(19) United States
(12) Patent Application Publication
(10) Pub. No.: US 2007/0043887 A1
(43) Pub. Date: Feb. 22, 2007

(54) [ADAPTOR DEVICE FOR MS MEMORY CARD INTERFACE]

(75) Inventors: Chih-Ling Wang, TAIPEI (TW); Chien-An Chen, TAIPEI (TW); Wee-Kuan Gan, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien. (TW)

(21) Appl. No.: 11/161,753

(22) Filed: Aug. 16, 2005

(51) Int. Cl. G06F 13/38

(52) U.S. Cl. 710/62

(57) ABSTRACT

An adaptor device for MS memory card interface is disclosed. The adaptor device comprises a MS memory card connecting interface connected to a first microcontroller, a second microcontroller and a memory card connecting interface. When the MS memory card connecting interface is connected to a host end and a memory card is connected to the memory card connecting interface, the host end can command to the memory card for data transmitting, meanwhile, the first microcontroller converts the command or the transmitted data from the host end into an acceptable format for the second microcontroller and transmits to the second microcontroller, and the second microcontroller converts the received command or data into an acceptable format for the memory card and transmits to the memory card for storage. Because the second microcontroller is a programmable microcontroller, the second microcontroller can be programmed according to the various type of the memory card and thereby reduce the manufactural cost.

### BACKGROUND OF THE INVENTION

1. Field of the Invention

The present invention relates to an adaptor device for MS memory card interface, and more particularly to an adaptor device that enables the host end to save/retrieve data to/from the memory card via the MS memory card interface.

2. Description of Related Art

The computer technologies are progressively upgraded everyday, and to fit the latest upgraded technologies into our everyday life activities has become the present trend. As a matter of fact, there are numerous portable electronic devices available on the market, for example, electronic dictionary, electronic translator and digital camera, all such portable electronic devices require computer either during or after operation thereof. Taking the digital camera as an example, unlike the conventional camera, the picture is not captured into a film, instead, the digital camera converts the image into the digital data and records it into the memory card, then these digital data may be converted and transmitted to the computer for storage or display, or to print out.

With advancement of the technology, the memory card has the advantages with small size and larger storage capacity compared to the conventional disk. Examples of latest memory cards on the market are secure digital card (SD), multi media card (MMC), compact flash card (CF) and smart media card (SM), which can be designed with small size and larger data storage capacity. In 1998, the memory stick alliance of Sony developed a memory stick (MS) has occupy a high percentage of the market share. Because of the advantageous features of protecting data in the memory stick, the memory stick is applied in almost every kind of portable electronic devices, such as notebook, digital camera and digital video camera. Nowadays, the application of the memory stick has also expanded into the electronic device, such as walkman, cellular phone, car stereo system and household stereo system.

However, the memory stick is more expensive compared other types of memory cards, and therefore, although most electronic devices are equipped with the memory stick interface slot, the user still rather purchase other types of inexpensive memory cards. Besides, most of the electronic devices only provide one type of the memory card, thus forbidding the users to replace the memory card with other specification. For electronic devices to be able to read different types of the memory cards, the electronic device must be equipped with corresponding types of reading devices. Thus, not only the cost of the electronic device is substantially increased but also renders the electronic device heavier, thicker, taller and bigger. Furthermore, longer time is required to switch various types of adaptor for saving or retrieving data to/from various memory cards and thereby causing inconvenience.

Therefore, to adapt various types of storage devices into the readable format for a common MS interface, as well as to overcome the disadvantage of repeatedly switching the adaptor is highly desirable. Furthermore, to reduce overall cost is also highly desirable.

### SUMMARY OF THE INVENTION

According to an aspect of the present invention, the adaptor device for MS memory card interface has a programmable second microcontroller so that the control program can be written therein for the various memory cards. Thus, the inventory of various types of the second microcontrollers in the warehouse may be effectively reduced. Therefore, the manufactural cost can be substantially reduced and also it is possible to reduce the price of the product.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram of an adaptor device for MS memory card interface according to a preferred embodiment of the present invention.

FIG. 2 is a block diagram of an adaptor device for MS memory card interface according to another preferred embodiment of the present invention.

FIG. 3 is a block diagram of a signal transmission of FIG. 2.

FIG. 4 is a block diagram of an adaptor device for MS memory card interface according to another preferred embodiment of the present invention.

FIG. 5 is a block diagram of an adaptor device for MS memory card interface according to another preferred embodiment of the present invention.

### DESCRIPTION OF PREFERRED EMBODIMENTS

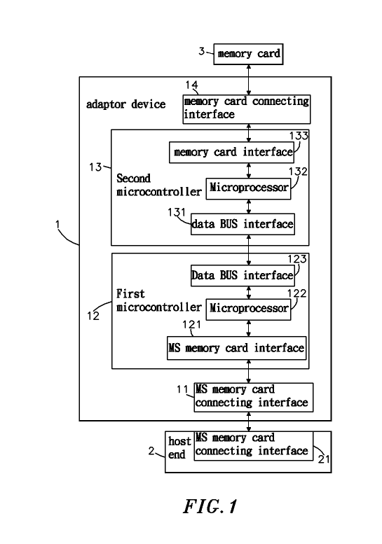

Referring to FIG. 1, an adaptor device 1 in accordance with the present invention is shown comprised of a MS memory card connecting interface 11, a first microcontroller 12, a second microcontroller 13 and a memory card connecting interface 14.

The MS memory card connecting interface 111 is electrically connected to a MS memory card connecting interface 21 of a host end 2.

The first microcontroller 12 comprises a MS memory card interface 121 connected to a microprocessor 122 and a data BUS interface 123.

The second microcontroller 13 is a programmable microcontroller, and the second microcontroller 13 comprises a data BUS interface 131 that is identical to the data BUS interface 123 of the first microcontroller 12. The data BUS interface 131 is connected to a microprocessor 132 and a memory card interface 133, and the data BUS interface 131 is electrically connected to the data BUS interface 123 of the first microcontroller 12.

The memory card connecting interface 14 is connected to the memory card interface 133 of the second microcontroller 13 for connecting a memory card 3.

When the MS memory card connecting interface 11 of the adaptor device 1 is electrically connected to the MS memory card connecting interface 21 of the host end 2 and the memory card connecting interface 14 is connected to the memory card 3, the host end 2 is capable of saving or retrieving data to or from the memory card 3. When the host 2 commands the memory card 3 to save in a format acceptable to the MS memory card interface 121, a command is transmitted to the MS memory card interface 121 of the first microcontroller 12 via MS memory card connecting interface 21 of the host end 2 and the MS memory card connecting interface 11 of the adaptor device 1, and the microprocessor 122 converts the command received by the MS memory card interface 121 into an acceptable format for the data USB interface 123, and the converted command is transmitted to the microprocessor 132 via the data BUS interface 123 of the first microcontroller 12 and the data BUS interface 131 of the second microcontroller 13. Next, the microprocessor 132 converts the received command into an acceptable format for the memory card interface 133 and then transmits to the memory card interface 133 for storage. Meanwhile, the data for the host end 2 to be stored is transmitted to the microprocessor 122 via the MS memory card connecting interface 11 and the MS memory card interface 121, and the microprocessor 122 converts the data into the acceptable format for the data BUS interface 123 and then transmits to the microprocessor 132 of the second microcontroller 13 via the data BUS interface 123. Then, the microprocessor 132 converts the data into the acceptable format for the memory card interface 133 and transmits to the memory card 3 for storage.

When the host 2 commands the memory card 3 to read in a format of the MS memory card interface 121, a read command is transmitted to the MS memory card interface 121 of the first microcontroller 12 via the MS memory card connecting interface 21 of the host end 2 and the MS memory card connecting interface 11 of the adaptor device 1, and the microprocessor 122 converts the read command received by the MS memory card interface 121 into an acceptable format for the data BUS interface 123, and then the converted read command is transmitted to the microprocessor 132 via the data BUS interface 123 of the first microcontroller 12 and the data BUS interface 131 of the second microcontroller 13. The microprocessor 132 converts the received read command into an acceptable format for the memory card interface 133 and then transmits to the memory card interface 133 to complete the read command. Meanwhile, data in the memory card 3 to be read by the host end 2 is transmitted to the microprocessor 132 via the memory card interface 133, and the microprocessor 132 converts the data into the acceptable format for the data BUS interface 131. The data BUS interface 131 continues to transmit the data to the microprocessor 122 of the first microcontroller 12 to convert the data into the acceptable format for the MS memory card interface 121, and the MS memory card interface 121 transmits the converted data to the host end 2. Thus, the MS memory card connecting interface 21 of the host end 2 can save/retrieve data to/from the memory cards 3 with the various interfaces through the adaptor device 1 to provide greater convenience to the users.

Furthermore, the second microcontroller 13 of the adaptor device 1 in the present invention is a programmable microcontroller, therefore, the adaptor device 1 can be designed according to the format of the memory card 3 required by the user to write a control program into the second microcontroller 13. Thus, different types of second microcontroller 13 need not to be stored in the warehouse. Accordingly, the manufactural cost can be substantially reduced and the flexibility of the production can be substantially increased. Besides, the second microcontroller 13 can be a FPGA or a CPLD.

Additionally, the host end 2 can be a desktop computer or a notebook, and the data BUS interface 123 of the first microcontroller 12 and the data USB interface 131 of the second microcontroller 13 can be an IDE interface or a SRAM interface. The transmitted data can be 8 bytes or 16 bytes. The memory card interface 133 of the second microcontroller 13 can be a secure digital card (SD) interface, a multi media card (MMC) interface, a compact flash card (CF) interface or a smart media card (SM) interface. The memory card connecting interface 14 can be a secure digital card (SD) adaptor interface, a multi media card (MMC) adaptor interface, a compact flash card (CF) adaptor interface or a smart media card (SM) adaptor interface.

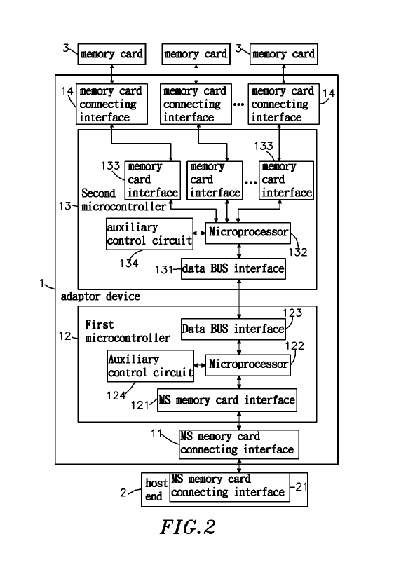

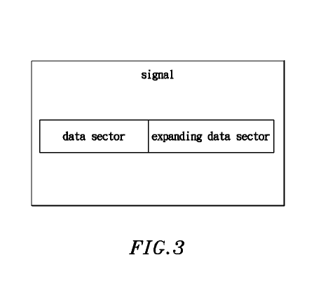

Referring to FIGS. 2 and 3, the microprocessor 122 of the first microcontroller 12 and the microprocessor 132 of the second microcontroller 13 are respectively connected to an auxiliary control circuit 124 and 134. The auxiliary control circuit 124 and 134 are capable of identifying whether the signal transmitted by the data BUS interface 123 and 131 is data or command. The transmission signal of the command is 1 byte and the transmission signal of the data is 512 plus 16 bytes, wherein, 512 byte is a data sector and 16 byte is an expanding data sector to save the information of the memory card 3, for example, ready, busy, CRC error, command error and so on. Each byte is formed by 8 bits or 16 bits.

Furthermore, the adaptor device 1 comprises a plurality of the memory card connecting interfaces 14, and the microprocessor 132 of the second microcontroller 13 is connected to a plurality of the memory card interface 133 with various formats. Each memory card interface 133 is connected to one memory card connecting interface 14 respectively. Thus, the host end 2 can process reading or saving to the various memory card 3 to provide convenience to the users.

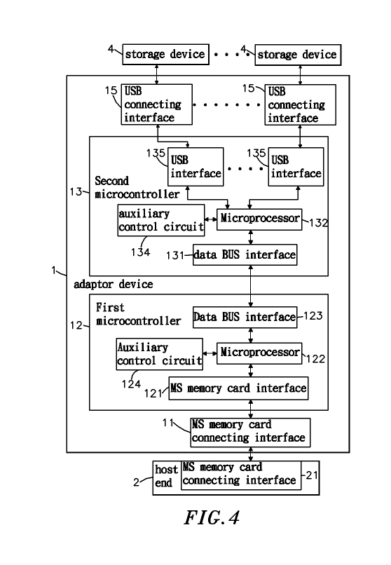

The embodiment disclosed in FIG. 4 is similar to the above described embodiment except for the second microcontroller 132 is connected to a plurality of USB interface 135, and each USB interface 135 is connected to one of a plurality of USB connecting interface 15 of the adaptor device 1, thus the MS memory card connecting interface 21 of the host end 2 can save/retrieve to storage devices 4 connected to the USB connecting interfaces 15 via the adaptor device 1, and with the same data and command transmission method as described in the previous embodiment.

Additionally, the storage device 4 can be a portable memory stick or a hard disk.

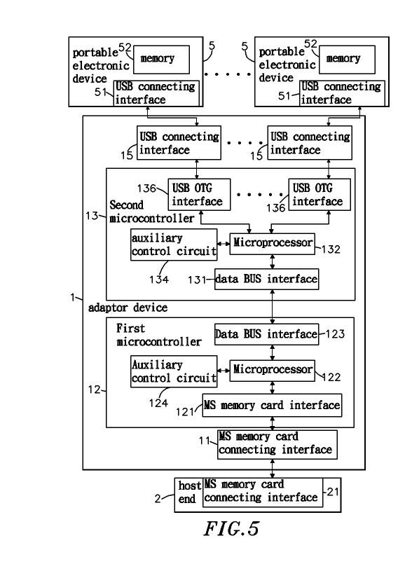

Referring to FIG. 5, the microprocessor 132 of the second microcontroller 13 connects to a plurality of USB OTG interface 136, and each USB OTG interface 136 is connected to one USB connecting interface 15 of the adaptor device 1. The USB OTG interface 136 provides a point-to-point connection method to connect two devices without the path of the computer or other host. When a USB connecting interface 51 of a portable electronic device 5 is connected to the USB connecting interface 15 of the adaptor device 1, the USB OTG interface 136 provides a driving program for the portable electronic device 5. Thus, the host end 2 can save/retrieve data in a memory 52 of the portable electronic device 5 via the adaptor device 1, and with the same data and command transmission method as the previous embodiment.

Furthermore, the portable electronic device 5 can be a digital camera, a cellular phone or a PDA.

The adaptor device 1 has at least the following advantages.

1. When the adaptor device 1 is adopted for connecting to the MS memory card connecting interface 21 of the host end 2 and the memory card 3 is connecting to the adaptor device 1, the first microcontroller 12 and the second microcontroller 13 of the adaptor device 1 can convert the command and the data format for transmission between the host end 2 and the memory card 3, thus memory card 3 with different specifications can implement data transmission with the host end 2 via the MS memory card connecting interface 21.

2. The second microcontroller 13 is adopted for converting the data and command format for the memory card 3, and the second microcontroller 13 is a programmable microcontroller. Thus, various control programs can be programmed into the second microcontroller 13, and therefore the manufactural cost can be reduced and thereby reduce the overall cost.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. An adaptor device for MS memory card interface comprising:
a MS memory card connecting interface, adapted for connecting electrically to a MS memory card connecting interface of a host end;
a first microcontroller, comprising a MS memory card interface connected to a microprocessor and a data BUS interface;
a second microcontroller, being a programmable microcontroller and comprising a data BUS interface identical to said data BUS interface of said first microcontroller, and said data BUS interface connected to a microprocessor and a memory card interface;
a memory card connecting interface, connected to said memory card interface of said second microcontroller, and said memory card connecting interface is adopted for connecting a memory card; and
wherein when said host end processes data saving to said memory card, said first microcontroller converts command or data of said host end into an acceptable format of said data BUS interface and transmits to said second microcontroller, and said second microcontroller converts said received command or data into an acceptable format for said memory card and then transmits to said memory card for storage; when said host end processes data reading from said memory card, said second microcontroller converts command or data of said memory card into an acceptable format of said data BUS interface and transmits to said first microcontroller, and said first microcontroller converts said received command or data into an acceptable format of said MS memory card interface and then transmits to said host end.

2. The adaptor device for MS memory card interface according to claim 1, wherein said second microcontroller comprises FPGA or CPLD.

3. The adaptor device for MS memory card interface according to claim 1, wherein said memory card interface and said memory card connecting interface comprise one or more.

4. The adaptor device for MS memory card interface according to claim 1, wherein said memory card interface comprises a secure digital card (SD) or a multi media card (MMC) interface.

5. The adaptor device for MS memory card interface according to claim 1, wherein said host end comprises a desktop computer or a notebook.

6. The adaptor device for MS memory card interface according to claim 1, wherein said data BUS interface of said first microcontroller and said second microcontroller comprise an IDE interface or a SRAM interface.

7. The adaptor device for MS memory card interface according to claim 1, wherein said microprocessor of said first microcontroller and said second microcontroller are respectively connected to an auxiliary control circuit capable of identifying whether a received signal is a data or a command.

8. An adaptor device for MS memory card interface comprising:
a MS memory card connecting interface, adapted for connecting electrically to a MS memory card connecting interface of a host end;
a first microcontroller, comprised a MS memory card interface connected to a microprocessor and a data Bus interface;
a second microcontroller, being a programmable microcontroller and comprising a data Bus interface identical to said data BUS interface of said first microcontroller and said data BUS interface connected to a microprocessor and a USB interface;
a USB connecting interface, connected to said USB interface of said second microcontroller, and said USB connecting interface adopted for connecting a storage device; and
wherein when said host end processes data saving to said storage device, said first microcontroller converts command or data of said host end into an acceptable format of said data BUS interface and transmits to said second microcontroller, and said second microcontroller converts said received command or data into an acceptable format for said storage device and then transmits to said storage device for storage; when said host end processes data reading from said storage device, said second microcontroller converts command or data of said storage device into an acceptable format of said data BUS interface and transmits to said first microcontroller, and said first microcontroller converts said received command or data into an acceptable format of MS memory card interface and then transmits to said host end.

9. The adaptor device for MS memory card interface according to claim 8, wherein said second microcontroller can be a FPGA or a CPLD.

10. The adaptor device for MS memory card interface according to claim 8, wherein said USB connecting interface and said USB interface comprise one or more.

11. The adaptor device for MS memory card interface according to claim 8, wherein said host end comprises a desktop computer or a notebook.

12. The adaptor device for MS memory card interface according to claim 8, wherein said data BUS interface of said first microcontroller and said second microcontroller comprise an IDE interface or a SRAM interface.

13. The adaptor device for MS memory card interface according to claim 8, wherein said microprocessor of said first microcontroller and said second microcontroller are respectively connected to an auxiliary control circuit capable of identifying whether a received signal is a data or a command.

14. The adaptor device for MS memory card interface according to claim 8, wherein said storage device comprises a portable memory stick or a hard disk.

15. An adaptor device for MS memory card interface comprising:
a MS memory card connecting interface, adapted for connecting electrically to a MS memory card connecting interface of a host end;
a first microcontroller, comprising a MS memory card interface connected to a microprocessor and a data Bus interface;
a second microcontroller, being a programmable microcontroller and comprising a data Bus interface identical to said data BUS interface of said first microcontroller and said data BUS interface connected to a microprocessor and a USB OTG interface;
a USB connecting interface, connected to said USB OTG interface of said second microcontroller, and said USB connecting interface adopted for connecting a portable electronic device; and
wherein when a USB connecting interface of said portable electronic device is connected to said USB connecting interface of said adaptor device, said USB OTG interface provides a driving program for said portable electronic device so that said host end can process data saving/retrieving to said portable electronic device via said adaptor device.

16. The adaptor device for MS memory card interface according to claim 15, wherein said second microcontroller comprises FPGA or CPLD.

17. The adaptor device for MS memory card interface according to claim 15, wherein said USB connecting interface and said USB OTG interface comprise one or more.

18. The adaptor device for MS memory card interface according to claim 15, wherein said host end comprises a desktop computer or a notebook.

19. The adaptor device for MS memory card interface according to claim 15, wherein said data BUS interface of said first microcontroller and said second microcontroller comprise an IDE interface or a SRAM interface.

20. The adaptor device for MS memory card interface according to claim 15, wherein said microprocessor of said first microcontroller and said second microcontroller are respectively connect to an auxiliary control circuit capable of identifying whether a received signal is a data or a command.

21. The adaptor device for MS memory card interface according to claim 15, wherein said portable electronic device comprises a cellular phone or a digital camera.
